(19) United States
(12) Patent Application Publication
(10) Pub. No.: US 2012/0059888 A1
(43) Pub. Date: Mar. 8, 2012

(54) Communication System And Method For Communicating Over A Communication System

(76) Inventors: Rain Johanson, Tallinn (EE); Aleksei Potov, Mountain View, CA (US)

(21) Appl. No.: 13/225,019

(22) Filed: Sep. 2, 2011

(30) Foreign Application Priority Data
Sep. 2, 2010 (GB) 1014616.5

(51) Int. Cl. G06F 15/16

(52) U.S. Cl. 709/206; 709/217

(57) ABSTRACT

A communication system and method for communicating over the communication system are provided. The communication system includes a client executed at a user terminal, a front end server and a plurality of other nodes. Data packets of a point-to-point communication are transmitted between the client and one of the other nodes. A persistent connection is provided between the client and the front end server, and the communication system is configured to use the persistent connection to provide support for the point-to-point communication between the client and said one of the other nodes.

### RELATED APPLICATION

This application claims priority under 35 U.S.C. §119 or 365 to Great Britain Application No. 1014616.5, filed Sep. 2, 2010. The entire teachings of the above application are incorporated herein by reference.

### TECHNICAL FIELD

The present invention relates to a communication system and a method for communicating over a communication system.

### BACKGROUND

Communication systems allow users to communicate with each other. Each user can be associated with a user terminal such that data packets can be transmitted between the user terminals in order for the users to communicate over the communication system. The data packets may be transmitted over a network such as the Internet.

Each user terminal may execute a communication client, provided by a software provider associated with the communication system, which allows the user terminal to engage in calls and instant messaging communication sessions over the network.

In a point to point communication system, in order for a first user to transmit a message to a second user, point-to-point communication is used in which the first user terminal (used by the first user) transmits the message directly to the second user terminal (used by the second user) using the Internet Protocol (IP) address of the second user terminal. In this way, in a point-to-point communication data packets are transmitted directly between the clients (i.e. without directing the data packets to servers).

Server based communication systems usually provide more reliable communication paths for transmitting data between clients as compared to P2P communication systems. However, server based communication systems do not cope so well as P2P communication systems with very large numbers of users in the system because in that case large processing demands are placed on the servers of the server based communication systems.

Some point to point communication systems use servers for IP address look up, in this case the client is required to establish a connection with an address look up server each time the client wishes to establish a connection with a server. Setting up connections with the appropriate server again places demands on the resources of the client.

### SUMMARY

According to a first aspect of the invention there is provided a communication system comprising: a client executed at a user terminal; a front end server; and a plurality of other nodes, wherein the communication system is configured to transmit data packets of a point-to-point communication between the client and one of the other nodes, and wherein a persistent connection is provided between the client and the front end server, the communication system being configured to use the persistent connection to provide support for the point-to-point communication between the client and said one of the other nodes.

According to a second aspect of the invention there is provided a method of communicating over a communication system, said communication system comprising a client executed at a user terminal, a front end server and a plurality of other nodes, wherein a persistent connection is provided in the communication system between the client and the front end server, the method comprising: transmitting data packets of a point-to-point communication between the client and one of the other nodes in the communication system, wherein the persistent connection is used to provide support for the point-to-point communication between the client and said one of the other nodes.

The data packets transmitted between the client and the other nodes provide point-to-point communication between the client and the other nodes. Preferably the communication system is configured to transmit data packets from the client to the other nodes via the front end server using the persistent connection between the client and the front end server. The client may have another connection with the communication system (other than the persistent connection) for use in the point-to-point communication.

The inventors have realized that it can be beneficial for there to be a persistent connection between the client and the front end server. In this way the front end server can provision back end communication services to the client over the persistent connection to thereby provide support for the point-to-point communication between the client and the other nodes in the communication system. Service requests sent from the client can be identified by using a service identifier (service ID). Messages can be relayed between the client and the appropriate server using a service ID.

As such services can be effectively multiplexed over the persistent connection using the service ID. For example, a service ID may indicate that the message is an instant message to be sent to an instant messaging server. Alternatively the service ID may indicate that the message is a premium video message to be sent to the premium video gateway server.

Data packets transmitted to the client via the front end server may be addressed using an identifier of the front end server and an identifier of the persistent connection. The data packets may be messages. Alternatively, the data packets may comprise call data for use in a call over the communication system.

In preferred embodiments, the front end server is a connection adapter. Having a persistent connection between the client and the connection adapter enables messages to be pushed to the client at any time. This also enables the client to be addressed using the identity of the connection adapter and the persistent connection. This offers a more robust method of communicating between clients rather than relying on point-to-point message delivery. Furthermore a persistent connection with the front end server allows the front end server to actively control aspects of a point-to-point communication session, such as billing and the storage of instant messages transmitted between clients over the communication system.

In preferred embodiments, the persistent connection is a Transmission Control Protocol (TCP) connection. The connection is persistent in the sense that while the client is logged into the communication system, the connection between the client and the front end server is constantly open. However, when the client is not logged into the communication system (e.g. if the user terminal is switched off, or the user terminal loses a connection to the interne) then the connection between the client and the front end server is broken. So the term “persistent” only refers to the time during which the client is logged into the communication system.

By sending data packets, such as messages, to multiple services over an already established connection (i.e. the persistent connection) rather than creating a new connection for each data packet, resources are saved that would otherwise be required for encryption handshake, authorization and registration of the client in order to establish a connection.

Preferred embodiments allow for point-to-point communication over the communication system between the client and the front end server and allow for a persistent connection to a front end server to be used to provide support for the point-to-point communication. In this sense, the communication system can be thought of as implementing a hybrid point-to-point, server architecture.

In the point-to-point communication data packets are transmitted directly to the end points of the point-to-point communication using the IP address of the end points. This means that data packets may be transmitted directly between clients in the point-to-point communication, without addressing the data packets using the servers to which the clients are connected. The point-to-point communication may comprise an instant messaging communication session between the client and said one of the other nodes, and the data packets may be instant messages. In this case, the communication system may be further configured to use the persistent connection to provide support for the instant messaging communication session between the client and said one of the other nodes by: transmitting the instant messages to a storage server in the communication system via the front end server using the persistent connection; and storing the instant messages at the storage server. The communication system may be further configured to allow the other nodes to retrieve the instant messages stored at the storage server.

Alternatively, the point-to-point communication may comprise a premium communication session between the client and said one of the other nodes wherein at least one user in the premium communication session is required to have a premium subscription status for allowing the premium communication session to proceed. In this case, the communication system may be further configured to use the persistent connection to provide support for the premium communication session between the client and said one of the other nodes in that the front end server determines whether at least one user in the premium communication session has the premium subscription status.

### BRIEF DESCRIPTION OF THE DRAWINGS

For a better understanding of the present invention and to show how the same may be put into effect, reference will now be made, by way of example, to the following drawings in which:

FIG. 1 shows a communications network according to a preferred embodiment;

FIG. 2 shows a schematic diagram of a user terminal according to a preferred embodiment;

FIG. 3 illustrates a method of transmitting an instant message from a first client to a second client; and

FIG. 4 is a schematic diagram of a communication system for handling a multiparty video communication session.

### DETAILED DESCRIPTION

Preferred embodiments of the invention will now be described by way of example only.

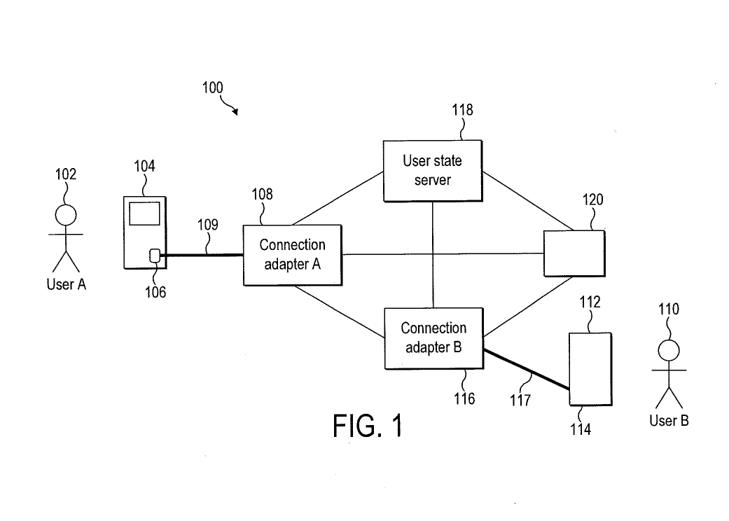

Reference is first made to FIG. 1, which illustrates a packet-based communication system 100 of a preferred embodiment. A first user of the communication system (User A 102) operates a user terminal 104, The user terminal 104 may be, for example, a mobile phone, a personal digital assistant (“PDA”), a personal computer (“PC”) (including, for example, Windows™, Mac OS™ and Linux™ PCs), a gaming device or other embedded device able to communicate over the communication system 100. The user terminal 104 is arranged to receive information from and output information to the user 102 of the device. In a preferred embodiment the user terminal 104 comprises a display such as a screen and an input device such as a keypad, joystick, touch-screen, keyboard, mouse, microphone and/or webcam.

The user terminal 104 is executing a communication client 106, provided by the software provider associated with the communication system 100. The communication client 106 is a software program executed on a local processor in the user terminal 104 which allows the user terminal 104 to engage in calls and instant messaging communication sessions over the communication system 100. The communication client 106 has a persistent connection 109 with a connection adapter 108. The connection adapter 108 is a front end server in the communication system 100. While the client 106 is executed at the user terminal 104, the client 106 is constantly connected to the connection adapter 108 to provide the persistent connection 109.

The communication system 100 also includes a second connection adapter 116, a user state server 118 and another node 120. The four nodes shown in FIG. 1 of the connection adapters 108 and 116, the user state server 118 and the other node 120 can all transmit data to each of the others of those four nodes, as depicted in FIG. 1. As would be apparent to a person skilled in the art, the communication system 100 may include more nodes than those shown in FIG. 1. The elements (or “nodes”) of the communication system 100 shown in FIG. 1 can communicate with each other over a network, which may be, for example, the Internet.

FIG. 1 also shows a second user 110 (User B) who has a user terminal 112 which executes a client 114 in order to communicate over the communication system 100 in the same way that the user terminal 104 executes the client 106 to communicate over the communication system 100. Therefore users A and B (102 and 110) can communicate with each other over the communication system 100. There may be more users in the communication system 100, but for clarity only the two users 102 and 110 are shown in the communication system 100 in FIG. 1. The communication client 114 has a persistent connection 117 with connection adapter 116. The connection adapter 116 is a front end server in the communication system 100. When the client 114 is executed at the user terminal 112, the client 114 is constantly connected to the connection adapter 116 to provide the persistent connection 117.

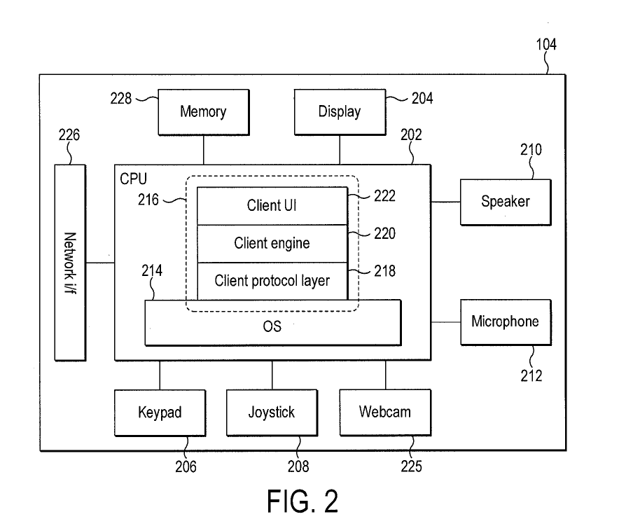

FIG. 2 illustrates a detailed view of the user terminal 104 on which is executed client 106. The user terminal 104 comprises a central processing unit (“CPU”) 202, to which is connected a display 204 such as a screen, input devices such as a keypad (or a keyboard) 206, a pointing device such as a joystick (or mouse) 208 and a webcam 225 for capturing video data. The display 204 may comprise a touch screen for inputting data to the CPU 202. An output audio device 210 (e.g. a speaker) and an input audio device 212 (e.g. a microphone) are connected to the CPU 202. The display 204, keypad 206, joystick 208, webcam 225, output audio device 210 and input audio device 212 are integrated into the user terminal 104. In alternative user terminals one or more of the display 204, the keypad 206, the joystick 208, webcam 225, the output audio device 210 and the input audio device 212 may not be integrated into the user terminal 104 and may be connected to the CPU 202 via respective interfaces. One example of such an interface is a USB interface. The CPU 202 is connected to a network interface 226 such as a modem for communication with the network of the communication system 100 for communicating over the communication system 100. The network interface 226 may be integrated into the user terminal 104 as shown in FIG. 2. In alternative user terminals the network interface 226 is not integrated into the user terminal 104. The network interface 226 provides means for maintaining the persistent connection 109 with the connection adapter 108.

FIG. 2 also illustrates an operating system (“OS”) 214 executed on the CPU 202. Running on top of the OS 214 is a software stack 216 for the client 106. The software stack shows a client protocol layer 218, a client engine layer 220 and a client user interface layer (“UI”) 222. Each layer is responsible for specific functions. Because each layer usually communicates with two other layers, they are regarded as being arranged in a stack as shown in FIG. 2. The operating system 214 manages the hardware resources of the computer and handles data being transmitted to and from the network via the network interface 226. The client protocol layer 218 of the client software communicates with the operating system 214 and manages the connections over the communication system 100. Processes requiring higher level processing are passed to the client engine layer 220. The client engine 220 also communicates with the client user interface layer 222. The client engine 220 may be arranged to control the client user interface layer 222 to present information to the user via a user interface of the client and to receive information from the user via the user interface.

Preferred embodiments of the operation of the communication system 100 will now be described. The clients 106 and 114 connect to the communication system 100 using the respective persistent connections 109 and 117 (which may be TCP connections) to the respective connection adapters 108 and 116. The connection adapters 108 and 116 are components which accept the persistent connections 109 and 117 and translate connection requests from the clients to registry calls. In response to the registry calls the connection adapters 108 and 116 can determine where to transmit data received from the clients 106 and 114 in the communication system 100. The clients 106 and 114 maintain connections (109 and 117) to the connection adapters (108 and 116) at all times that the clients are logged into the communication system 100. The connection adapters (108 and 116) can issue notifications to any connected client (106 and 114) at any moment.

Information about all of the clients (e.g. clients 106 and 114) connected to the communication system 100 is stored in the user state server 118. The user state server 118 may also be referred to as a “client registry”. The user state server 118 is a mapping table which holds entries containing information about which users are using which clients and to which front end servers those clients are connected. For example, the user state server 118 may store an entry comprising (i) a user ID identifying the user 102 and (ii) a front end server ID identifying the connection adapter 108 to which the client 106 is connected by the persistent connection 109. The entry may also comprise an ID of the persistent connection 109 which is used to connect the client 106 to the connection adapter 108. When the client 106 connects to the connection adapter 108, user and client information is registered in an entry in the user state server 118. The information for the entry may, for example, be transmitted to the user state server 118 from the client 106 or from the connection adapter 108 responsive to the client 106 connecting to the connection adapter 108 using the persistent connection 109.

The user state server 118 also provides an interface allowing services within the communication system 100 to query the information stored in the entries at the user state server 118. Any service can request to receive the information from an entry in the user state server 118. When a service intends to send a message to a particular user, the service can use the received information from the user state server 118 to determine which connection adaptor and/or which persistent connection the client of the particular user is connected to. The service can then transmit the message to the specified connection adapter which will forward it to the client such that the message can be delivered to the particular user.

Commands and notifications (e.g. service requests) passing in both directions between the client 106 and the connection adapter 108 can be serialized attribute containers. In this case, each command has a particular format and has a command name, a service ID and a request ID in addition to data. When a command arrives from the client 106 at the connection adapter 108, the connection adapter queries the service ID in the command to determine where the command should be transmitted to and then passes the command to the corresponding service identified by the service ID. The service may be provided by a server in the communication system 100. The server can respond to a service request by providing a service to the client 106 via the connection adapter 108 and the persistent connection 109.

Data packets sent over the communication system 100 from the client 106 may, for example, be instant messages or call data for use in a call over the communication system 100. A data packet may be an instant message. Alternatively, an instant message may comprise multiple data packets. A data packet can therefore be at least a part of an instant message. The client 106 is able to communicate with the client 114 over the communication system 100 using the persistent connection 109 between the client 106 and the connection adapter 108 and using the persistent connection 117 between the client 114 and the connection adapter 116. Additionally, the client 106 may be able to communicate with the client 114 over the communication system 100 using connections that are not shown in FIG. 1. In this way, the users 102 and 110 can engage in point-to-point communication over the communication system 100, and the point-to-point communication can be supported using the connection adapters 108 and 116 and the persistent connections 109 and 117.

The clients 106 and 114 can engage in point-to-point communication over the communication system 100, and the connection adapters 108 and 116 can control various aspects of the point-to-point communication. This can help to provide a greater flexibility to the communication services provided in the point-to-point communication and can also offer a more robust method of communicating over the communication system 100 than relying on peer to peer delivery of messages over the network. For example, data packets can be sent between the clients 106 and 114 via the front end servers 108 and 116 using the persistent connections 109 and 117.

It should be noted that each connection adapter in the communication system 100 may be connected to more than one client with a respective more than one persistent connection.

Two examples of how connection adapters can provide support for a point-to-point communication are explained in detail below.

### 1. The Use of Connection Adapters for Instant Messaging

One example of support that can be provided for point-to-point communication by the connection adapters 108 and 116 is the storage of instant messages transmitted between the clients 106 and 114 in an instant messaging communication session. Each of the instant messages in an instant messaging conversation between the clients 106 and 114 can be stored on a database at a server (i.e. a “storage server”) in the communication system 100. This allows a user to use different instances of the client at different user terminals in the communication system and still gain access to the chat history (i.e. the instant messages transmitted in previous instant messaging conversations) from the database at the server in the communication system 100. This provides greater flexibility for users to use different clients throughout the communication system 100. The use of the connection adapters in the communication system 100 provides a simple method to implement the storage of the instant messages.

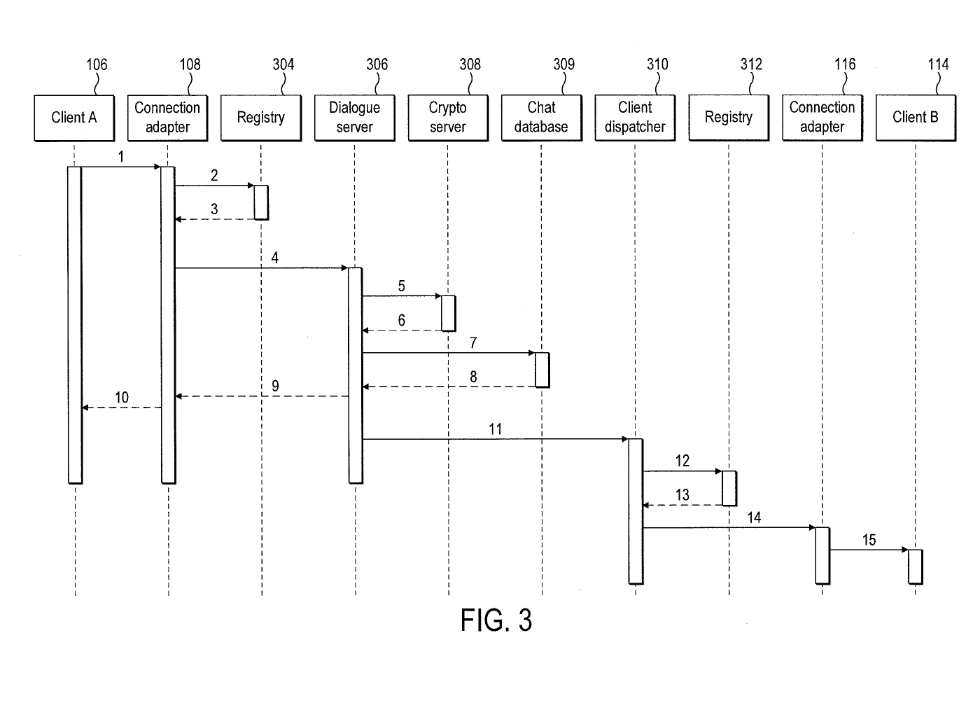

An instant messaging method according to preferred embodiments will now be described with reference to FIG. 3. The instant messaging conversation may include more than two users, as is known in the art, and the instant messages may be transmitted between any of the users in the conversation.

FIG. 3 shows various elements of the communication system 100. In particular, FIG. 3 shows the clients 106 and 114 of the user terminals 104 and 112. FIG. 3 also shows first and second connection adapters 108 and 116, first and second registries 304 and 312 (which may or may not be the same as the user state server 118 shown in FIG. 1), a dialogue server 306, a crypto server 308, a database 309 and a client dispatcher 310. The first and second connection adapters 108 and 116, the first and second registries 304 and 312, the dialogue server 306, the crypto server 308, the database 309 and the client dispatcher 310 are implemented at a plurality of server nodes in the communication system 100. The first and second registries 304 and 312 may be implemented as one single registry (e.g. the user state server 118) or as separate registries in the communication system 100.

The arrows marked 1 to 15 in FIG. 3 show steps in the method of transmitting an instant message from the client 106 at the first user terminal 104 to the client 114 at the second user terminal 112, as described below.

In step 1 the client 106 sends an instant message to the connection adapter 108. The connection adapter 108 is used in this arrangement as a front end server to provision various back end services to the client 106. The instant message includes a service ID which indicates to the connection adapter 108 that the message is an instant message.

In step 2 the connection adapter 108 queries the registry 304 for the address in the communication system 100 of the dialogue server 306. In step 3 the registry 304 returns the address of the dialogue server 306 to the connection adapter 108.

In step 4 the connection adapter 108 provides the instant message (together with metadata, such as a timestamp and the identity of the first user 102 and the second user 110) to the dialogue server 306.

In step 5 the dialogue server 306 sends the instant message to the crypto server 308. The crypto server 308 encrypts the instant message and in step 6 returns the encrypted instant message to the dialogue server 306.

In step 7 the dialogue server 306 transmits the encrypted instant message to the database 309 for storage thereon. The instant message is stored as a sent message in user 102's mailbox and as a received message in user 110's mailbox on the database 309. The full chat history for the conversation is saved regardless of whether the second user 110 is offline or online in the communication system 100.

In steps 8, 9 and 10 a response message is transmitted from the database 309 to the client 106 at the first user terminal 104, via the dialogue server 306 and the connection adapter 108, indicating the status of the “store message” operation, i.e. whether the instant message has been stored at the database 309. If the client 106 does not receive an affirmative response message then the client 106 will resend the instant message in the conversation.

FIG. 3 shows the scenario in which the second user 110 is online when the first user 102 transmits an instant message to the second user terminal 112 for the second user 110. In step 11 the dialogue server 306 sends a query to the client dispatcher 310 identifying the second user 110. This query may include the identity of the second user 110 which was received at the dialogue server 306 from the connection adapter 108 in step 4.

In step 12 the client dispatcher 310 queries the client registry 312 to determine which connection adapter the second user 110 is connected to and which TCP connection the second user 110 is connected to the connection adapter on. In step 13 when the second user 110 is online in the communication system 100 then the client registry 312 replies to the client dispatcher 310 with the location of the second user 110 in the network. The location is defined by the address of the connection adapter 116 instance that the client 114 is connected to.

In step 14 the instant message is sent from the client dispatcher 310 to the connection adapter 116 identified in step 13, and in step 15 the instant message is sent from the connection adapter 116 to the client 114 at the second user terminal 112 over the TCP connection identified in step 13.

At the end of the method shown in FIG. 3 an instant message has been transmitted from the client 106 at the first user terminal 104 to the client 114 at the second user terminal 112. The instant message has also been stored in the database 309. The instant message is transmitted between the clients 106 and 114 via the connection adapters using the persistent connections. The instant messages may be additionally transmitted between the client 106 and 114 using other connections in the communication system 100.

It is noted that if the second user 110 is not online in the communication system 100 when an instant message, intended for the second user 110, is transmitted from the client 106, then the instant message is stored in the database 309 (e.g. by following steps 1 to 10 shown in FIG. 3), but the message is not immediately transmitted to the second user terminal 112.

The first user 102 may, for example, start using a third user terminal (not shown in FIG. 1). The first user 102 may then want to view his chat history over the communication system 100. The chat history (i.e. the instant messages for each user for each conversation) can be retrieved from the database 309. In order to retrieve the chat history at the third user terminal the user 102 can transmit a message update request from the third user terminal to the database 309. The message update request may include an identifier of the last instant message received at the third user terminal for the user 102. The database 309 can then determine which of the instant messages stored thereon were transmitted in instant messaging conversations after the time of the last instant message received at the third user terminal for the user 102. The database 309 can then transmit those determined instant messages to the third user terminal such that the user 102 can gain access to his full chat history at the third user terminal.

Therefore, using the methods described above, the chat history can be synchronized over multiple instances of the client for a user. This is achieved in the preferred embodiments described above by storing the instant messages of a conversation in the database 309, whereby the database 309 is accessible by different user terminals in the communication system 100.

### 2. The Use of Connection Adapters for Controlling Premium Subscription Services

Another example of support that can be provided for the point-to-point communication by the connection adapters 108 and 116 is a scheme for controlling payment for premium subscription services in the communication system 100 (e.g. for engaging in premium communication sessions). For example, in order to engage in a multiparty video call (which is one type of premium communication session), at least one of the users in the multiparty video call may be required to have a premium video subscription status with the communication system 100. The connection adapters in the communication system 100 can be used to control premium subscription services over the communication system 100.

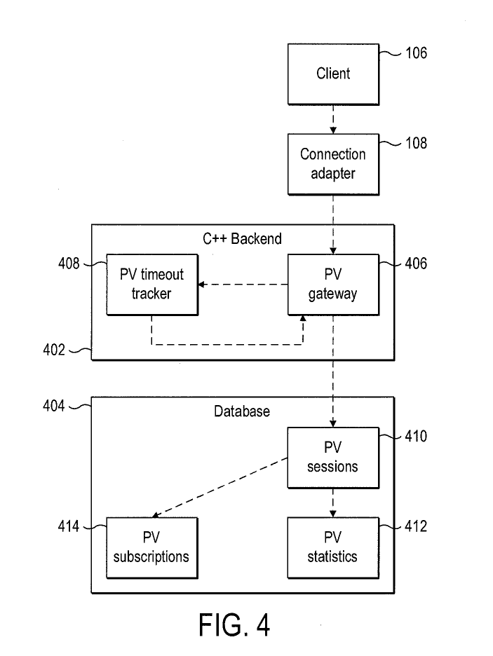

FIG. 4 shows the client 106 communicating with the connection adapter 108. In order for the client 106 to engage in premium services over the communication system 100, the connection adapter 108 can communicate with other servers in the communication system 100 to control the client 106's use of premium services. For example, where the client 106 attempts to engage in a multiparty video call with other clients over the communication system 100 the connection adapter 108 can communicate with a C++ backend server 402 and a database 404 of the communication system 100 as shown in FIG. 4. The C++ backend server 402 comprises a premium video gateway block 406 and a premium video timeout tracker block 408. The database 404 comprises a premium video sessions block 410, a premium video statistics block 412 and a premium video subscriptions block 414, as depicted in FIG. 4.

The connection adapter 108 can communicate with the premium video gateway block 406. The premium video gateway block 406 can communicate with the premium video timeout tracker block 408 and with the premium video sessions block 410. The premium video sessions block 410 can also communicate with the premium video statistics block 412 and with the premium video subscriptions block 414.

The premium video subscriptions block 414 keeps a record of each user's subscription status in the communication system 100. A request to engage in a multiparty video call can be received at the premium video gateway block 406 from the client 106 via the connection adapter 108. The premium video gateway block 406 will forward the request to the premium video sessions block 410 which keeps a record of the premium video sessions that are/have been active in the communication system 100. The premium video sessions block 410 polls the premium video subscriptions block 414 and if any of the users intended to be in the multiparty video call have a valid subscription status for allowing the multiparty video call to proceed then the multiparty video call is allowed to proceed. The premium video timeout tracker block 408 can keep a record of the users' subscription status as the multiparty video call proceeds such that if the subscription status of the funding user expires during the multiparty video call then the multiparty video call may be ceased. In this event, the other users in the multiparty video call may be able to acquire a suitable premium subscription status in order to preserve the multiparty video call.

The use of the connection adapter 108 allows the client 106 to convert an existing multiparty call to a multiparty video call even if the user 102 does not have a suitable premium subscription status provided that one of the other users involved in the multiparty call does have a suitable subscription status. The connection adapter 108 can determine that one of the users does have the required premium subscription status by polling the C++ backend server 402 and the database 404 as described above. Similarly, if a funding caller for a multiparty video call leaves the call (or if his subscription expires during the call) then the connection adapter 108 can poll the C++ backend server 402 and the database 404 to determine whether any of the other users on the call have a sufficient subscription status for allowing the multiparty video call to proceed.

In the embodiments described above the client 106 has a persistent connection 109 with the connection adapter 108, whereby the connection adapter 108 is a front end server for the client 106. By using the connection adapter 108, communication over the communication system 100 by the client 106 can be routed through one connection (the persistent connection 109), such that resources are saved which would otherwise be required for encryption handshake, authorization and registration of the client 106 each time the client 106 transmits data across the communication system 100. In the preferred embodiment, these handshake authorization and registration steps are only required to be performed once, that is, when establishing the persistent connection 109 to the connection adapter 108. Furthermore, the identity of the connection adapter 108 can be used to address data packets to be sent to the client 106 since the client 106 is always connected to the connection adapter 108. This simplifies the addressing and routing of data packets to the client 106 and provides a more robust route through the network than compared to using a peer-to-peer approach to routing the data packets. Furthermore, the use of the connection adapter 108 allows various centralized functionality that would not be available using a peer to peer communication system, such as the storage of instant messages on centralized servers and the flexible provision of using a user's premium subscription status in the communication system for engaging in premium communication services over the communication system 100. The persistent connection 109 between the client 106 and the connection adapter 108 can be used to provide support for a point-to-point communication between the clients 106 and 114. The benefits of having the persistent connection 109 between the client 106 and the connection adapter 108 are therefore evident to a person skilled in the art.

It should be understood that the block, flow, and network diagrams may include more or fewer elements, be arranged differently, or be represented differently. It should be understood that implementation may dictate the block, flow, and network diagrams and the number of block, flow, and network diagrams illustrating the execution of embodiments of the invention.

It should be understood that elements of the block, flow, and network diagrams described above may be implemented in software, hardware, or firmware. In addition, the elements of the block, flow, and network diagrams described above may be combined or divided in any manner in software, hardware, or firmware. If implemented in software, the software may be written in any language that can support the embodiments disclosed herein. The software may be stored on any form of non-transitory computer readable medium, such as random access memory (RAM), read only memory (ROM), compact disk read only memory (CD-ROM), flash memory, hard drive, and so forth. In operation, a general purpose or application specific processor loads and executes the software in a manner well understood in the art.

While this invention has been particularly shown and described with reference to preferred embodiments, it will be understood to those skilled in the art that various changes in form and detail may be made without departing from the scope of the invention as defined by the appendant claims.

What is claimed is:

1. A communication system comprising:
a client executed at a user terminal;
a front end server; and
a plurality of other nodes,
wherein the communication system is configured to transmit data packets of a point-to-point communication between the client and one of the other nodes,
and wherein a persistent connection is provided between the client and the front end server, the communication system being configured to use the persistent connection to provide support for the point-to-point communication between the client and said one of the other nodes.

2. The communication system of claim 1 further comprising a further client executed at said one of the other nodes wherein the point-to-point communication is between said client and said further client.

3. The communication system of claim 2 further comprising a further front end server, wherein a further persistent connection is provided between the further client and the further front end server, and wherein the communication system is configured to use the further persistent connection to provide further support for the point-to-point communication between the client and said further client.

4. The communication system of claim 1 wherein the communication system is further configured to transmit the data packets from the client to said one of the other nodes via the front end server using the persistent connection between the client and the front end server.

5. The communication system of claim 1 wherein the point-to-point communication comprises an instant messaging communication session between the client and said one of the other nodes, and wherein the data packets are instant messages.

6. The communication system of claim 5 wherein the communication system is further configured to use the persistent connection to provide support for the instant messaging communication session between the client and said one of the other nodes by:
transmitting the instant messages to a storage server in the communication system via the front end server using the persistent connection; and
storing the instant messages at the storage server.

7. The communication system of claim 6 wherein the communication system is further configured to allow the other nodes to retrieve the instant messages stored at the storage server.

8. The communication system of claim 1 wherein the point-to-point communication comprises a premium communication session between the client and said one of the other nodes wherein at least one user in the premium communication session is required to have a premium subscription status for allowing the premium communication session to proceed.

9. The communication system of claim 8 wherein the communication system is further configured to use the persistent connection to provide support for the premium communication session between the client and said one of the other nodes by:
the front end server determining whether at least one user in the premium communication session has the premium subscription status.

10. The communication system of claim 1 further comprising a user state server for storing an entry comprising (i) a user identifier identifying a user of the client and (ii) a front end server identifier identifying the front end server to which the client is connected by the persistent connection.

11. The communication system of claim 10 wherein the communication system is configured such that responsive to the client connecting to the front end server using the persistent connection, said entry is transmitted to the user state server for storage thereon.

12. The communication system of claim 1 wherein a data packet transmitted from the client to the front end server comprises a service identifier, and wherein the front end server is configured to use the service identifier to determine which of the other nodes in the communication system to transmit the data packet to.

13. The communication system of claim 12 wherein the data packet is at least a part of an instant message for communication to a further user terminal in the communication system and the service identifier identifies the data packet as at least a part of an instant message, such that the front end server can determine to transmit the data packet to the further user terminal.

14. The communication system of claim 12 wherein the data packet is a service request for communication to a further server in the communication system and wherein the service identifier identifies the data packet as a service request, such that the front end server can determine to transmit the data packet to the further server.

15. The communication system of claim 1 wherein one of the other nodes is a further server configured to provide services to the client.

16. The communication system of claim 1 wherein the persistent connection is a Transmission Control Protocol connection.

17. A method of communicating over a communication system, said communication system comprising a client executed at a user terminal, a front end server and a plurality of other nodes, wherein a persistent connection is provided in the communication system between the client and the front end server, the method comprising:
transmitting data packets of a point-to-point communication between the client and one of the other nodes in the communication system,
wherein the persistent connection is used to provide support for the point-to-point communication between the client and said one of the other nodes.

18. The method of claim 17 further comprising transmitting the data packets between the client and said one of the other nodes via the front end server using the persistent connection between the client and the front end server.

19. The method of claim 17 wherein data packets transmitted to the client via the front end server are addressed using an identifier of the front end server and an identifier of the persistent connection.

20. The method of claim 17 further comprising:
transmitting an entry to a user state server of the communication system; and
storing the entry at the user state server, wherein said entry comprises (i) a user identifier identifying a user of the client and (ii) a front end server identifier identifying the front end server to which the client is connected by the persistent connection.

21. The method of claim 20 wherein said step of transmitting an entry to a user state server is performed responsive to the client connecting to the front end server using the persistent connection.

22. The method of claim 20 further comprising:
said one of the other nodes sending a query to the user state server to retrieve said entry;
said one of the other nodes using said user identifier and said front end server identifier to identify the front end server; and
said one of the other nodes transmitting data packets intended for the user to the client via the front end server.

23. The method of claim 17 wherein said one of the other nodes in the communication system is a further user terminal executing a further client, and wherein the point-to-point communication is between said client and said further client.

24. The method of claim 17 wherein the data packets are messages.

25. The method of claim 17 wherein the data packets comprise call data for use in a call over the communication system.
